(19) United States
(12) Patent Application Publication
(10) Pub. No.: US 2008/0007673 A1
(43) Pub. Date: Jan. 10, 2008

(54) LIQUID CRYSTAL DISPLAY DEVICE

(76) Inventors: Yasuhisa Shiraishi, Mobara (JP); Seiichi Nishiyama, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/768,233

(22) Filed: Jun. 26, 2007

(30) Foreign Application Priority Data
Jul. 7, 2006 (JP) 2006-187384

(51) Int. Cl. G02F 1/13357

(52) U.S. Cl. 349/65

(57) ABSTRACT

A liquid-crystal display device is provided which includes: a display panel; a backlight that applies light onto the display panel; a light emitting device of the backlight; a light guide into which the light from the light emitting device comes; and a mold around the light guide, wherein the mold reflects the light from the light emitting device.

### BACKGROUND OF THE INVENTION

1. Field of the Invention

The present invention relates to the light source of nonluminous display devices, and more particularly, to a liquid-crystal display device having a backlight that uses an LED as a light source with a light guide.

2. Background Art

Liquid-crystal display devices have been frequently used as display devices in recent years. Particularly, liquid-crystal display devices have been used for the displays of portable equipment because of their thin, lightweight, and energy saving features.

However, liquid-crystal display devices need illuminating means because they are not of emissive type.

Popular lighting units used in liquid-crystal display devices include planar lighting units called backlights. Cold-cathode Fluorescent Lamp tubes have been generally used as the light-emitting devices (also referred to as light sources) of the backlights, while LEDs (light-emitting diodes) are also used as the light-emitting devices.

The backlights have a planar light guide. The light guide is made of light-transmissive resin, so that light incident on the light guide from the light-emitting devices transmits through the light guide. The light guide has reflecting or dispersing members such as grooves, protrusions, or prints. The reflecting or dispersing members cause the light that transmits through the light guide to advance toward the liquid-crystal display device.

The use of LEDs as light-emitting devices poses the problem of difficulty in letting out uniform light from the light guide because they are point light sources. To cope with such a problem, for example, JP-A-9-092886 proposes a technique of dispersing the light around the LEDs evenly.

Another arrangement is also known in which the light-exiting portions of LEDs have lenses so that uniform light can exit from the LEDs.

### SUMMARY OF THE INVENTION

Backlights that use a plurality of LEDs as light-emitting devices so as to emit high-luminance light have separate light-emitting points. This makes it difficult to emit uniform light in the incident surface of the light guide. Even when lenses are particularly disposed at the light-exiting portions of LEDs in consideration of the dispersion of the light from the LEDs, it is difficult to eliminate darkness to be caused between the LEDs.

According to a first aspect of the invention, there is provided a liquid-crystal display device including: a display panel; a backlight that applies light onto the display panel; a light emitting device of the backlight; a light guide into which the light from the light emitting device comes; and a mold around the light guide. The mold has slopes inclined with respect to the light incident surface of the light guide. The light from the light emitting device is advanced also along the light incident surface of the light guide. The light traveling along the light incident surface of the light guide is reflected by the slopes toward the light incident surface of the light guide.

Thus, the light can be introduced to the light guide through between the LEDs, so that dark portions to be generated between the LEDs can be reduced. In other words, the light that is emitted from the LEDs and travels in parallel to the light incident surface of the light guide is directed forward of the slopes using the slopes provided to the mold, so that the light can be introduced to the light guide ahead of the slopes. This increases the light that enters perpendicularly on the light incident surface of the light guide even from between LEDs.

According to a second aspect of the invention, there is provided a liquid-crystal display device including a liquid crystal panel; and a planar lighting unit that applies light onto the liquid crystal panel. The planar lighting unit includes: a light guide having a light exiting surface and a bottom surface facing the light exiting surface. The light guide has side faces crossing the light exiting surface or the bottom surface. A plurality of LEDs is disposed along a first side of the light guide. The light of the LEDs is entered from the first side of the light guide to make the first side as the light incident surface. A mold is disposed around the light guide and the LEDs. The mold has slopes facing the light incident surface of the light guide.

A part of the light emitted from the LEDs is emitted along the light incident surface of the light guide the light traveling along the light incident surface of the light guide by the slopes is reflected toward the light incident surface of the light guide.

The above-described structure can thus increase the amount of light incident on the light guide from between adjacent two LEDs.

### BRIEF DESCRIPTION OF THE DRAWINGS

FIG. 1 is a plan view of a liquid-crystal display device according to an embodiment of the invention;

FIG. 2A is a schematic cross sectional view of a light emitting diode of the liquid-crystal display device according to an embodiment of the invention;

FIG. 2B is a light-exiting-side front view of the light emitting diode according to an embodiment of the invention.

FIG. 3A is a schematic perspective view of the light emitting diode of the liquid-crystal display device according to an embodiment of the invention;

FIG. 3B is a schematic cross sectional view of the same;

FIG. 4A is a schematic plan view of the light guide of the liquid-crystal display device according to an embodiment of the invention;

FIG. 4B is a schematic side view of the same;

FIG. 5A shows an optical path in the case where the grooves of the light guide project outward, according to an embodiment of the invention;

FIG. 5B shows an optical path in the case where the grooves are recessed inward, according to an embodiment of the invention;

FIG. 6 is a schematic plan view of the backlight according to an embodiment of the invention, showing a problem of the liquid-crystal display device having a plurality of light emitting devices;

FIG. 7 is a schematic plan view of the backlight according to an embodiment of the invention, in which the light incidence surface has curves;

FIG. 8 is a schematic plan view of the flexible board having white or high-reflectance members according to an embodiment of the invention;

FIG. 9 is a schematic plan view of the light guide and a mold that houses the light guide according to an embodiment of the invention;

FIG. 10 is a schematic plan view of the light guide and a mold that houses the light guide according to an embodiment of the invention; and

FIG. 11 is a schematic plan view of the light guide and the mold according to an embodiment of the invention.

### DESCRIPTION OF THE PREFERRED EMBODIMENTS

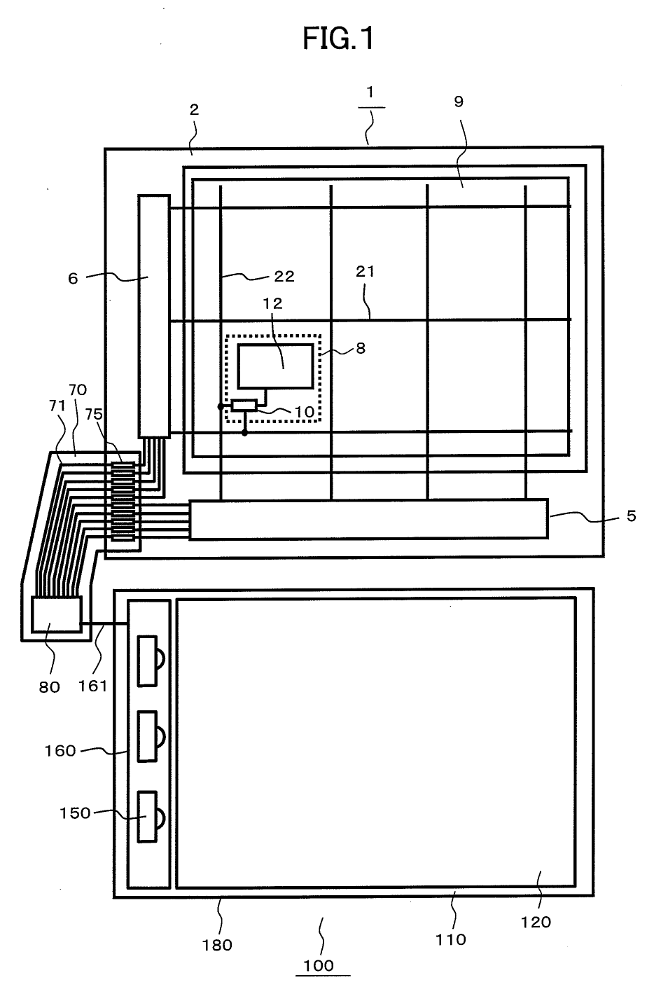

FIG. 1 is a plan view of a liquid-crystal display device 100 according to an embodiment of the invention. The liquid-crystal display device 100 includes a liquid crystal panel 1, a backlight 110, and a control circuit 80. Signals and supply voltage necessary for display on the liquid crystal panel 1 are fed from the control circuit 80. The control circuit 80 is mounted on a flexible board 70, from which signals are sent to the liquid crystal panel 1 through lines 71 and terminals 75.

The backlight 110 includes a light guide 120, LEDs 150, and a mold 180. The backlight 110 is disposed to illuminate the liquid crystal panel 1 with light. The light from the backlight 110 whose amount of transmission or reflection is controlled is used for the display on the liquid crystal panel 1. While the backlight 110 is placed on the back or front surface of the liquid crystal panel 1, as viewed from the viewer, FIG. 1 shows the backlight 110 below the liquid crystal panel 1 for the convenience of description.

The light guide 120 is substantially rectangular in shape and has the LEDs 150 on one side. Reference numeral 160 denotes a flexible board that electrically connects the LEDs 150. The flexible board 160 and the control circuit 80 are electrically connected by a line 161. For the interests of simplicity, a mold provided between the light guide 120 and the LEDs 150 is omitted. The details of the mold and the backlight 110 will be described later.

The liquid crystal panel 1 will now be described. A pixel section 8 of the liquid crystal panel 1 has a pixel electrode 12. While the liquid crystal panel 1 has a large number of the pixel sections 8 in matrix form, only one pixel section 8 is shown in FIG. 1 for the sake of simplicity. The matrix pixel sections 8 constitute a display region 9. The pixel sections 8 serve as the pixels of a display image to provide an image on the display region 9.

Referring to FIG. 1, the liquid crystal panel 1 has gate signal lines (also referred to as scanning lines) 21 which extend in the X direction and arranged in lines in the Y direction and drain signal lines (also referred to as video signal lines) 22 which extend in the Y direction and arranged in lines in the X direction. The gate signal lines 21 and the drain signal lines 22 intersect each other. The pixel sections 8 are each formed in the region surrounded by the gate signal lines 21 and the drain signal lines 22.

Each pixel section 8 has a switching element 10. A control signal is supplied through the gate signal line 21 to control the on-off action of the switching element 10. When the switching element 10 is turned on, a video signal sent to the pixel electrode 12 through the drain signal line 22.

The drain signal lines 22 are connected to a driving circuit 5. The driving circuit 5 outputs video signals. The gate signal lines 21 are connected to a driving circuit 6. The driving circuit 6 outputs control signals. The gate signal lines 21, the drain signal lines 22, the driving circuit 5, and the driving circuit 6 are formed on the same TFT substrate 2.

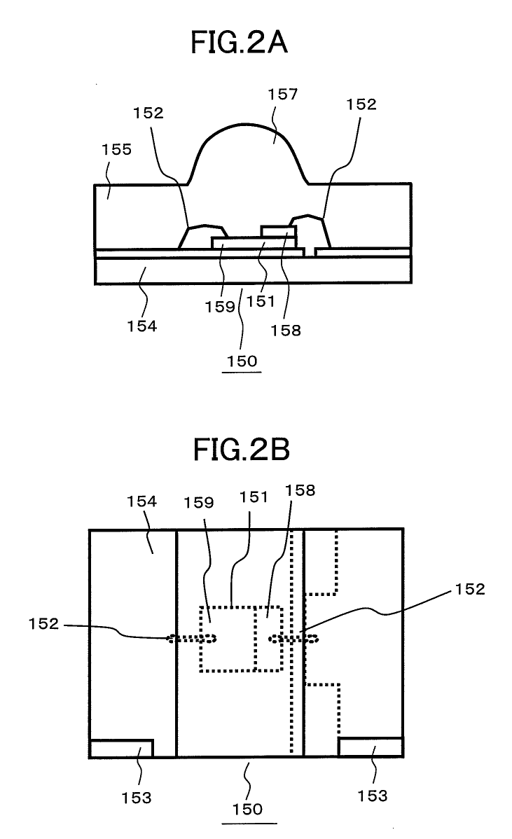

FIGS. 2A and 2B show the schematic structure of the LED 150 that is a light-emitting device, wherein FIG. 2A is a schematic cross sectional view of the LED 150, and FIG. 2B is a light-exiting-side front view of the same.

The LED 150 has a structure in which an LED chip 151 serving as a light emitter is mounted on a chip board 154. The LED chip 151 has a PN junction. When voltage is applied, the PN junction emits light of a specific wavelength. A P-type semiconductor layer of the PN junction has a P electrode (anode) 158, while an N-type semiconductor layer has an N electrode (cathode) 159.

The P electrode 158 and the N electrode 159 each connect to a wire 152. The wires 152 electrically connect the P electrode 158 and the N electrode 159 to chip terminals 153 for connecting the LED 150 externally, respectively.

The LED chip 151 may have a fluorescent emission section on the light exiting surface. The fluorescent emission section has the function of converting the wavelength of the light emitted from the LED chip 151. A lens portion 157 disperses the exiting light. A transparent resin portion 155 allows the light emitted from the LED chip 151 to pass therethrough to the front and the sides.

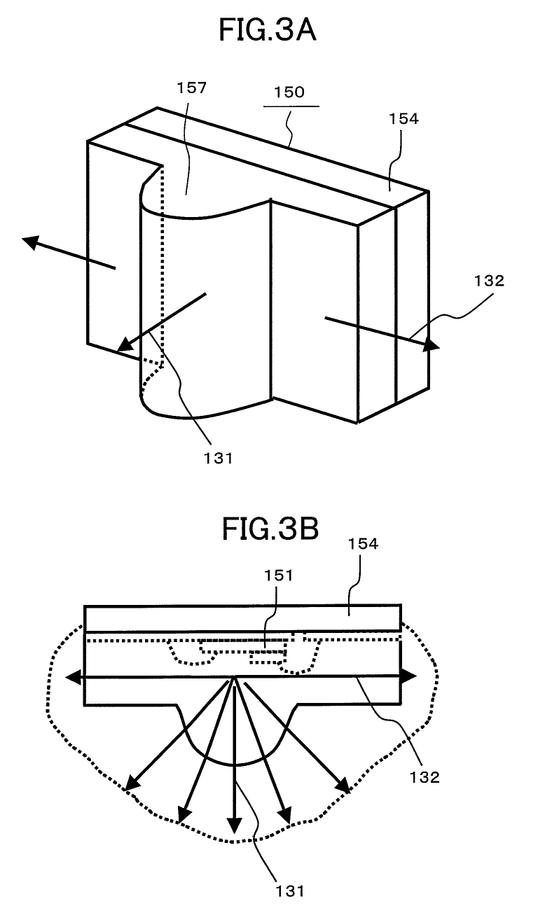

Referring then to FIGS. 3A and 3B, light emitted from the LED 150 will be described. FIG. 3A is a schematic perspective view of the LED 150, and FIG. 3B is a schematic cross sectional view of the same, which illustrate the exiting light.

The LED chip 151 emits light mainly along an arrow 131. The arrow 131 is perpendicular to the light-emitting surface of the LED chip 151 and directed to the front. The direction indicated by the arrow 131 is referred to as a main exiting direction.

In this embodiment, light exits also in directions crossing the main exiting direction 131. The directions crossing the main exiting direction 131 and along the chip board 154 are designated by arrows 132. The directions indicated by the arrows 132 are hereinafter also referred to as lateral directions.

The LED 150 shown in FIGS. 3A and 3B has the lens portion 157, through which the exiting light is dispersed evenly in the main exiting direction 131. The light exiting surface of the lens portion 157 is orthogonal to the exiting light so as to minimize the reflection and refraction of the light on the light exiting surface.

Light of angles lager than a predetermined angle is reflected at the boundary between the light guide 120 and air on the incident surface of the light guide 120 because of the refractivity of the light guide 120. Accordingly, the light exiting in the lateral directions 132 will not enter the light guide 120 or reflected by the light guide 120 because it is substantially parallel to the incident surface of the light guide 120.

This embodiment is constructed such that the light from the LEDs 150 travels also in the directions parallel to the incident surface of the light guide 120, and is reflected by the mold, to be described later, to the light guide 120, so that the amount of light that enters between the LEDs 150 is increased.

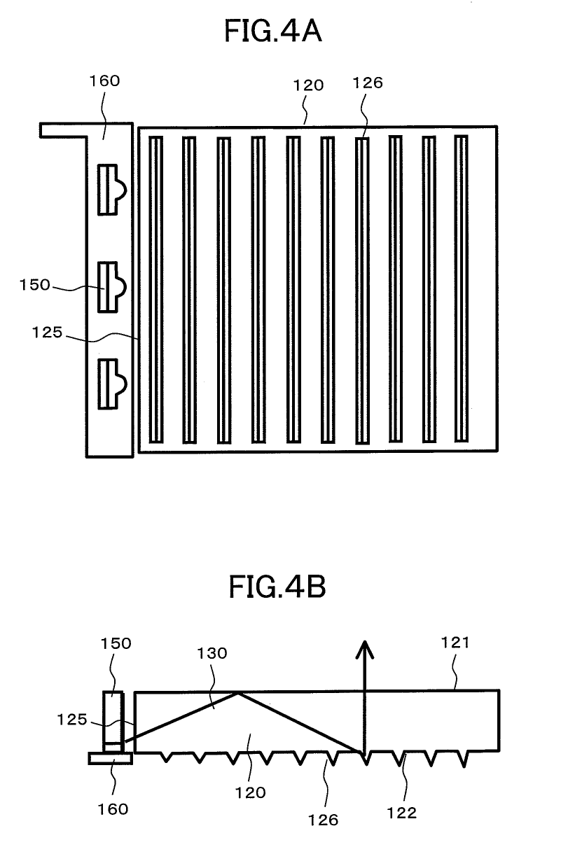

FIG. 4A shows a schematic plan view of the light guide 120, and FIG. 4B shows a schematic side view of the same. The light guide 120 is rectangular in shape as shown in FIG. 4A, and has a top face 121 and a bottom face 122, as shown in FIG. 4B. The light guide 120 is made of a light transmissive material such as acrylic resin, and has the shape of a plate with a thickness from 1.0 mm to 0.2 mm. Although the light guide 120 in FIG. 4B has a rectangular cross section, it may have a wedge shape whose thickness decreases from a light incident surface 125.

FIGS. 4A and 4B show the positional relationship between the light guide 120 and the LEDs 150. The LEDs 150 are disposed in the vicinity of the light incident surface 125 at least one side of the light guide 120. The LEDs 150 are disposed on the flexible board 160 and along the light incident surface 125.

The light that has exited from the LEDs 150 enters the light incident surface 125. Since the refractivity of the light guide 120 is higher than that of air, as described above, light incident on the light incident surface 125 at angles larger than a specified angle with respect to the normal to the light incident surface is reflected, while light incident at angles lower than that enters the light guide 120.

The top face 121 and the bottom face 122 of the light guide 120 are substantially perpendicular to the light incident surface 125. The bottom face 122 has V-grooves 126 serving as a reflector. The light that has come into the light guide 120 repeats total reflection between the top face 121 and the bottom face 122 to advance in the light guide 120. The light traveling in the light guide 120 is reflected by the grooves 126 provided on the bottom face 122 to the top face 121 and exits from the top face 121.

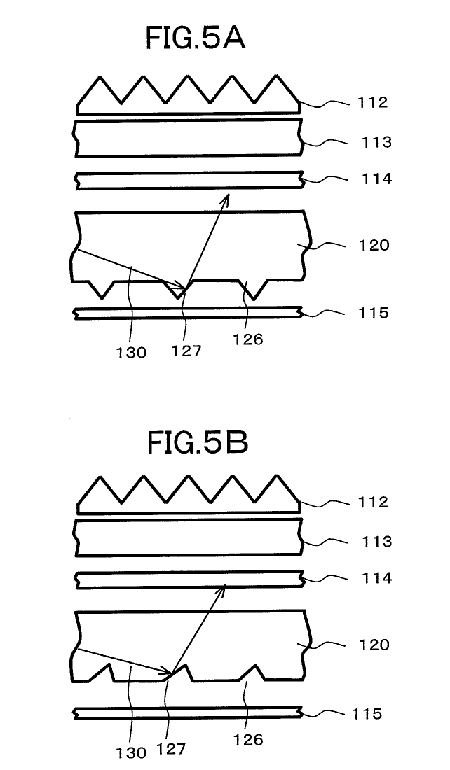

Referring to FIGS. 5A and 5B, the light reflected by the grooves 126 will be described. FIG. 5A shows a case in which the grooves 126 protrude outward, while FIG. 5B shows a case in which the grooves 126 are recessed inward. The grooves 126 each have a reflecting surface (also referred to as a slope) 127. The reflecting surface 127 forms an angle from 2 to 35 degrees with the bottom face 122. The light reflected by the reflecting surface 127 exits such that it expands externally at a large angle with respect to the line perpendicular to the top face 121 of the light guide 120 (at an obtuse angle with respect to the top face 121). Therefore, prism sheets 113 and 112 are disposed above the light guide 120 to reflect the outward light toward the liquid crystal panel (not shown). Numeral 114 denotes a diffuser, and numeral 115 designates a reflecting sheet.

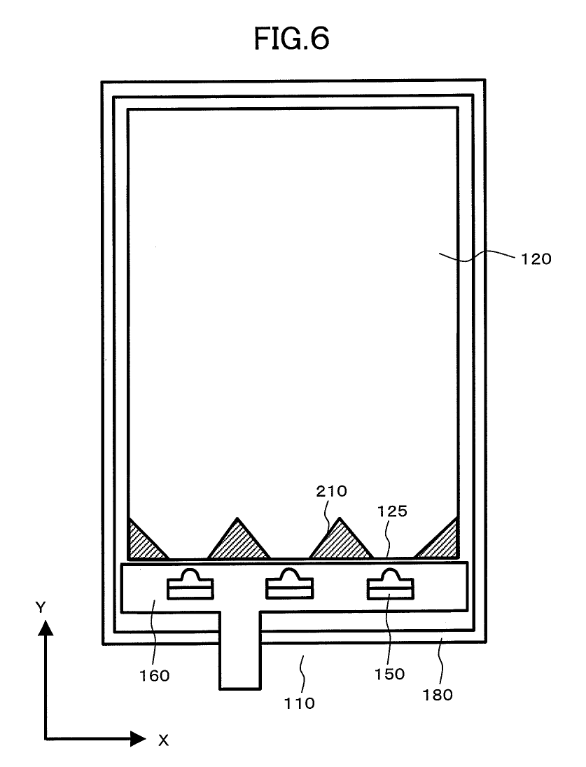

Referring to FIG. 6, the light in the neighborhood of the LEDs 150 will be described. The LEDs 150 are disposed to face the light incident surface 125 of the light guide 120. The main light exiting direction 131 (the Y direction in FIG. 6) of the LEDs 150 is substantially perpendicular to the light incident surface 125, so that most of the light exiting from the LEDs 150 enters the light guide 120.

Since light of angles above a predetermined angle with respect to the vertical direction to the light incident surface 125 is reflected by the light incident surface 125, as described above, extremely little light reaches the regions of the light incident surface 125 beyond the predetermined angle to form the dark regions 210.

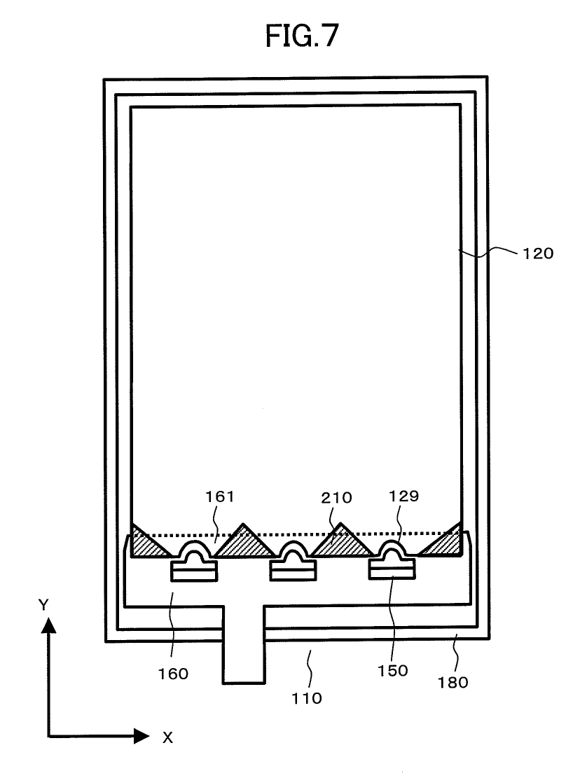

FIG. 7 shows the light incident surface 125 having curves 129 similar to the lens portions 157 of the LEDs 150 to decrease the dark region 210. The curves 129 are formed on the light incident surface 125 so as to face the lens portions 157. Since the light exiting from the lens portions 157 enters the curves 129 at right angles, thus enhancing the light utilization of the light guide 120.

Moreover, the light traveling in the X direction can also enter the light guide 120 because the curves 129 have surfaces substantially perpendicular to the X direction. This reduces the dark regions 210 to be formed between LEDs 150.

In FIG. 7, the distance between the lens portions 157 and the curves 129 is set small so as to achieve high light utilization. To that end, a portion 161 of the flexible board 160 on which the LEDs 150 are mounted overlaps with the light guide 120.

Specifically, since the lens portions 157 of the LEDs 150 are embedded in the concave portions of the curves 129, the portion 161 of the flexible board 160 located on the straight line connecting the LEDs 150 overlaps with the light guide 120.

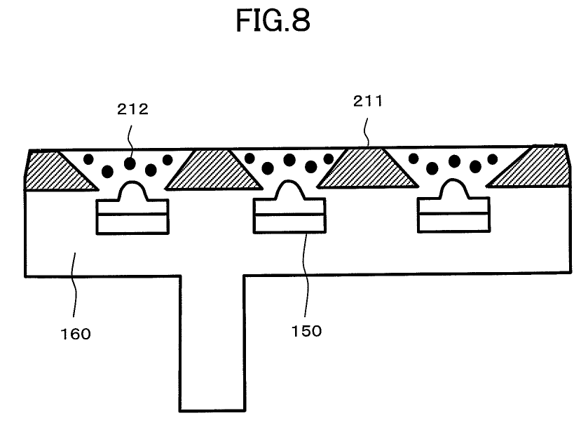

FIG. 8 shows the flexible board 160 having white or high-reflectance members 211. The flexible board 160 thus reflects light to the light guide 120, thereby enhancing the light utilization.

The flexible board 160 shown in FIG. 8 has the white or high-reflectance members 211 corresponding to the dark regions 210, and further has light-absorbing members 212 on the surface adjacent to the light incident surface 125 of LED 150. The light-absorbing members 212 have alternate black or gray dots of different sizes so as to adjust the amount of light reflected in the neighborhood of the LEDs 150.

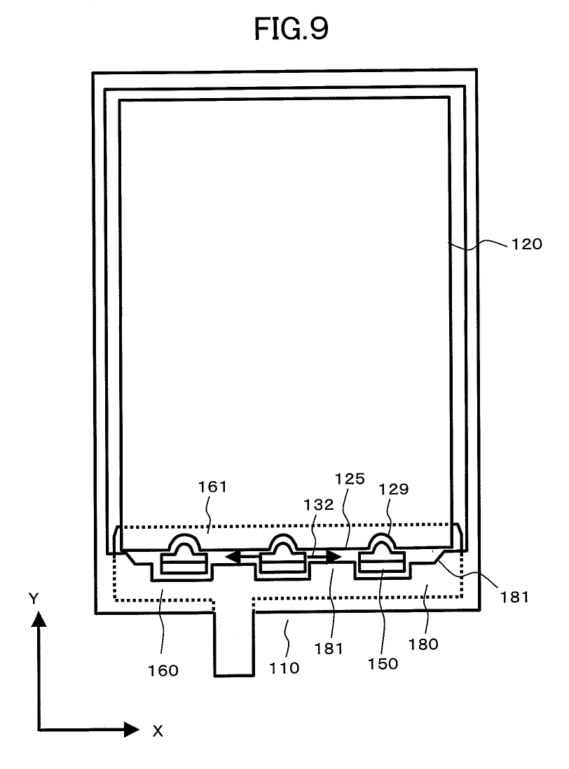

Referring next to FIG. 9, the mold 180 housing the light guide 120 will be described. The mold 180 has a shape that surrounds the light guide 120. The light guide 120 and the mold 180 are arranged close to each other on the side of the light guide 120 except the light incident surface 125, while they are illustrated separately for the convenience of illustration. The proximity of the light guide 120 and the mold 180 reduces the leakage of light therebetween, and allows the light exiting from the side to be reflected into the light guide 120 again.

In FIG. 9, part of the mold 180 adjacent to the back of the LEDs 150 is apart from the light incident surface 125, below in the drawing, because the LEDs 150 are present between the mold 180 and the light incident surface 125. However, part of the mold 180 between the LEDs 150 forms protrusions 181 close to the light incident surface 125.

The LEDs 150 emits light also in the direction along the light incident surface 125 (in the lateral direction 132). For that, a clearance is provided between the protrusions 181 and the light incident surface 125. The presence of the protrusions 181 allows the light from the LEDs 150 traveling in the lateral direction 132 to be reflected to the light guide 120, and allows the light that has exited from the light incident surface 125 to the mold 180 to be reflected to the light guide 120 again.

The flexible board 160 may have the high-reflectance members 211 and the light-absorbing members 212 shown in FIG. 8 (not shown in FIG. 9). Similarly, the other flexible boards of this embodiment may have the high-reflectance members 211 and the light-absorbing members 212 as necessary.

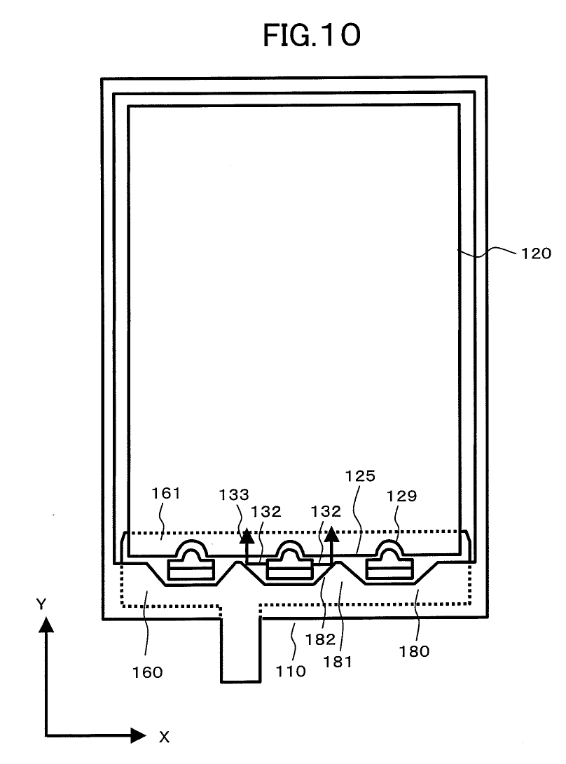

FIG. 10 shows the protrusions 181 having slopes 182. The light that has exited from the LEDs 150 in the lateral direction 132 along the light incident surface 125 is reflected by the slopes 182 to become light 133 directed to the light incident surface 125.

The light 133 reflected by the slopes 182 enters the light guide 120 between the LEDs 150, so that the dark regions 210 can be remarkably reduced. By controlling the angle of the slopes 182, the light 133 reflected by the slopes 182 can enter the light incident surface 125 of the light guide 120 substantially vertically.

Thus, the presence of the slopes 182 allows the light to enter through the part of the light incident surface 125 between the LEDs 150. This allows even the LEDs 150, or point light sources, to emit light substantially vertically with respect to the light incident surface 125.

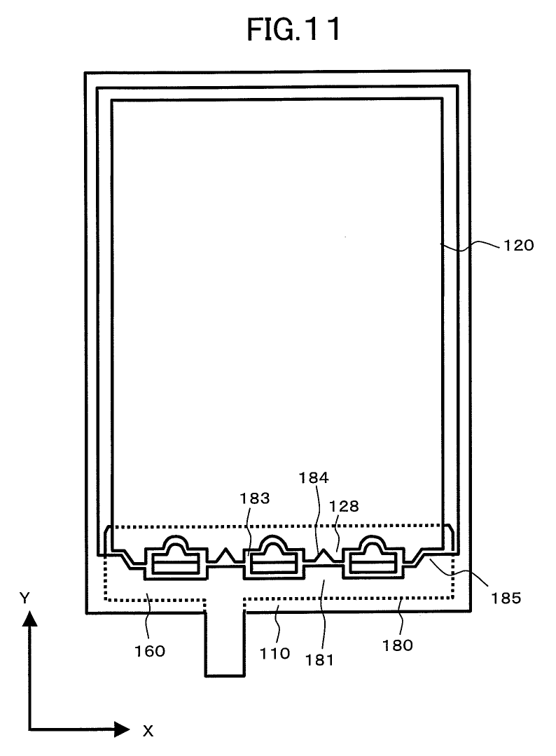

FIG. 11 shows a case in which the light guide 120 is disposed close to the protrusions 181. The light guide 120 has protrusions 128 such that they fill the clearance between the LEDs 150. The protrusions 128 of the light guide 120 and the protrusions 181 of the mold 180 form spaces 183, in which the LEDs 150 are housed.

The protrusions 128 of the light guide 120 have slopes 184. The slopes 184 reflect the light traveling along the light incident surface 125 into the light 133 that is directed to the light guide 120. The slopes 184 increase the amount of vertical light that enters the light incident surface 125 between the LEDs 150.

The light emitted from the LEDs 150 is also reflected in the inner surfaces of the spaces 183. Of the light reflected by the inner surfaces of the spaces 183, the light that has reached the light incident surface 125 at angles permitting entrance can enter the light guide 120, thus enhancing light utilization.

What is claimed is:

1. A liquid-crystal display device comprising:
a display panel;
a backlight that applies light onto the display panel;
a light emitting device of the backlight;
a light guide into which the light from the light emitting device comes; and
a mold around the light guide, wherein
the mold reflects the light from the light emitting device toward the light guide.

2. The liquid-crystal display device according to claim 1, wherein
the light emitting device is an LED.

3. The liquid-crystal display device according to claim 1, wherein
the light emitting device has a lens at its light-exiting portion.

4. A liquid-crystal display device comprising:
a display panel; and
a planar lighting unit that applies light onto the display panel, wherein
the planar lighting unit includes:
a plurality of light emitting devices;
a light guide that applies the light from the light emitting devices onto a liquid crystal panel;
a top face of the light guide facing the liquid crystal panel;
side faces crossing the top face, one of the side faces being adjacent to the light emitting devices; and
a mold around the light guide; wherein
the light emitting devices are arranged along the side face;
part of the light emitted from the light emitting devices travels toward the adjacent light emitting devices; and
the mold has slopes inclined with respect to the side face to reflect the light emitted from the light emitting devices toward the light guide.

5. The liquid-crystal display device according to claim 4, wherein
the light emitting device is an LED.

6. The liquid-crystal display device according to claim 4, wherein
the light emitting device has a lens at its light-exiting portion.

7. A liquid-crystal display device comprising:
a display panel; and
a light guide that applies light onto the display panel;
a plurality of light emitting devices that emit light toward the light guide;
a circuit board on which the light emitting devices are mounted; and
a mold around the light guide; wherein
the light guide has a light incident surface adjacent to the light emitting devices;
the light emitting devices are arranged on the circuit board and along a side face of the light guide;
part of the light emitted from the light emitting devices travels to the adjacent light emitting devices; and
the circuit board and the mold reflect the light that is emitted from the light emitting devices to the adjacent light emitting devices toward the light guide.

8. The liquid-crystal display device according to claim 7, wherein
the light emitting device is an LED.

9. The liquid-crystal display device according to claim 7, wherein
the light emitting device has a lens at its light-exiting portion.
